(19) United States
(12) Patent Application Publication
(10) Pub. No.: US 2017/0138901 A1
(43) Pub. Date: May 18, 2017

(54) ELECTRODE DRIVE AND SENSING CIRCUITS AND METHODS

(71) Applicant: IIIumina, Inc., San Diego, CA (US)

(72) Inventor: Kirkpatrick W. Norton, San Diego, CA (US)

(73) Assignee: IIIumina, Inc., San Diego, CA (US)

(21) Appl. No.: 15/347,291

(22) Filed: Nov. 9, 2016

Related U.S. Application Data
(60) Provisional application No. 62/256,638, filed on Nov. 17, 2015.
(60) Provisional application No. 62/399,721, filed on Sep. 26, 2016.

(51) Int. Cl. G01N 27/447; G01N 27/22; B01L 3/00

(52) U.S. Cl. CPC G01N 27/44791; B01L 3/50273; G01N 27/226; B01L 2400/0427; B01L 2300/0645; B01L 2200/10

(57) ABSTRACT

An electrode drive and sensing circuit and method are provided for a fluidics droplet actuator apparatus. The circuit comprises a droplet operations electrode. An electrowetting (EW) driver is connected to the droplet operations electrode by a signal path. The EW driver is to supply an electrowetting drive signal component to the droplet operations electrode. A capacitance measurement (CM) device is connected to the droplet operations electrode by the signal path. The CM device is to sense a sensing signal component indicative of at least one of a presence or absence of a droplet at the droplet operations electrode. A first coupling circuit is positioned between the EW driver and the droplet operations electrode along the signal path. A second coupling circuit is positioned between the CM device and the same droplet operations electrode along the signal path.

### CROSS-REFERENCE TO RELATED APPLICATIONS

The present application claims priority to U.S. Provisional Application No. 62/256,638, which was filed on Nov. 17, 2015 and is incorporated herein by reference in its entirety. The present application also claims priority to U.S. Provisional Application No. 62/399,721, which was filed on Sep. 26, 2016 and is also incorporated herein by reference in its entirety.

### BACKGROUND

A droplet actuator may include one or more substrates to form a surface or gap for conducting droplet operations. The one or more substrates establish a droplet operations surface or gap for conducting droplet operations and may also include electrodes arranged to conduct the droplet operations. The droplet operations substrate or the gap between the substrates may be coated or filled with a filler fluid that is immiscible with the liquid that forms the droplets. In droplet actuators, not every attempt to transport a droplet via droplet operations is successful. Currently, optical devices (e.g., cameras) are used to visualize the droplets to make sure they move when intended. However, in some instances optics systems may add cost and complexity to the system. Therefore, new approaches are needed for verifying and/or monitoring droplet operations.

### DEFINITIONS

All literature and similar material cited in this application, including, but not limited to, patents, patent applications, articles, books, treatises, and web pages, regardless of the format of such literature and similar materials, are expressly incorporated by reference in their entirety. In the event that one or more of the incorporated literature and similar materials differs from or contradicts this application, including but not limited to defined terms, term usage, described techniques, or the like, this application controls.

As used herein, the following terms have the meanings indicated.

“Activate,” with reference to one or more electrodes, means affecting a change in the electrical state of the one or more electrodes which, in the presence of a droplet, results in a droplet operation. Activation of an electrode can be accomplished using alternating current (AC) or direct current (DC). Any suitable voltage may be used. For example, an electrode may be activated using various voltages. For example, in one embodiment, an activation voltage may be between about 150V and 1000V. As another example, in one embodiment, the activation voltage may be between about 275V and 300V. As another example, in one embodiment, the activation voltage may be greater than about 200 V, or greater than about 250 V The term “about”, when qualifying a value, range or limit, shall generally include a tolerance understood in the field, such as (but not limited to) +/−10% of the stated value, range or limit. Where an AC signal is used, any suitable frequency may be employed. For example, an electrode may be activated using an AC signal having a frequency from about 1 Hz to about 10 MHz, or from about 10 Hz to about 60 Hz, or from about 20 Hz to about 40 Hz, etc. In one embodiment, the frequency is about 30 Hz.

“Droplet” means a volume of liquid on a droplet actuator. In one embodiment, a droplet is at least partially bounded by a filler fluid. For example, a droplet may be completely surrounded by a filler fluid or may be bounded by filler fluid and one or more surfaces of the droplet actuator. As another example, a droplet may be bounded by filler fluid, one or more surfaces of the droplet actuator, and/or the atmosphere. As yet another example, a droplet may be bounded by filler fluid and the atmosphere. Droplets may, for example, be aqueous or non-aqueous or may be mixtures or emulsions including aqueous and non-aqueous components. Droplets may take a wide variety of shapes; nonlimiting examples include generally disc shaped, slug shaped, truncated sphere, ellipsoid, spherical, partially compressed sphere, hemispherical, ovoid, cylindrical, combinations of such shapes, and various shapes formed during droplet operations, such as merging or splitting or formed as a result of contact of such shapes with one or more surfaces of a droplet actuator. For examples of droplet fluids that may be subjected to droplet operations using the approach of the present disclosure, see Eckhardt et al., International Patent Pub. No. WO/2007/120241, entitled, “Droplet-Based Biochemistry,” published on Oct. 25, 2007, the entire disclosure of which is incorporated herein by reference.

In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include a reagent, such as water, deionized water, saline solutions, acidic solutions, basic solutions, detergent solutions and/or buffers. A droplet can include nucleic acids, such as DNA, genomic DNA, RNA, mRNA or analogs thereof; nucleotides such as deoxyribonucleotides, ribonucleotides or analogs thereof such as analogs having terminator moieties such as those described in Bentley et al., Nature 456:53-59 (2008); Gormley et al., International Patent Pub. No. WO/2013/131962, entitled, “Improved Methods of Nucleic Acid Sequencing,” published on Sep. 12, 2013; Barnes et al., U.S. Pat. No. 7,057,026, entitled “Labelled Nucleotides,” issued on Jun. 6, 2006; Kozlov et al., International Patent Pub. No. WO/2008/042067, entitled, “Compositions and Methods for Nucleotide Sequencing,” published on Apr. 10, 2008; Rigatti et al., International Patent Pub. No. WO/2013/117595, entitled, “Targeted Enrichment and Amplification of Nucleic Acids on a Support,” published on Aug. 15, 2013; Hardin et al., U.S. Pat. No. 7,329,492, entitled “Methods for Real-Time Single Molecule Sequence Determination,” issued on Feb. 12, 2008; Hardin et al., U.S. Pat. No. 7,211,414, entitled “Enzymatic Nucleic Acid Synthesis: Compositions and Methods for Altering Monomer Incorporation Fidelity,” issued on May 1, 2007; Turner et al., U.S. Pat. No. 7,315,019, entitled “Arrays of Optical Confinements and Uses Thereof,” issued on Jan. 1, 2008; Xu et al., U.S. Pat. No. 7,405,281, entitled “Fluorescent Nucleotide Analogs and Uses Therefor,” issued on Jul. 29, 2008; and Rank et al., U.S. Patent Pub. No. 20080108082, entitled “Polymerase Enzymes and Reagents for Enhanced Nucleic Acid Sequencing,” published on May 8, 2008, the entire disclosures of which are incorporated herein by reference; enzymes such as polymerases, ligases, recombinases, or transposases; binding partners such as antibodies, epitopes, streptavidin, avidin, biotin, lectins or carbohydrates; or other biochemically active molecules. Other examples of droplet contents include reagents, such as a reagent for a biochemical protocol, such as a nucleic acid amplification protocol, an affinity-based assay protocol, an enzymatic assay protocol, a sequencing protocol, and/or a protocol for analyses of biological fluids. A droplet may include one or more beads.

“Droplet Actuator” means a device for manipulating droplets. For examples of droplet actuators, see Pamula et al., U.S. Pat. No. 6,911,132, entitled “Apparatus for Manipulating Droplets by Electrowetting-Based Techniques,” issued on Jun. 28, 2005; Pamula et al., U.S. Patent Pub. No. 20060194331, entitled “Apparatuses and Methods for Manipulating Droplets on a Printed Circuit Board,” published on Aug. 31, 2006; Pollack et al., International Patent Pub. No. WO/2007/120241, entitled “Droplet-Based Biochemistry,” published on Oct. 25, 2007; Shenderov, U.S. Pat. No. 6,773,566, entitled “Electrostatic Actuators for Microfluidics and Methods for Using Same,” issued on Aug. 10, 2004; Shenderov, U.S. Pat. No. 6,565,727, entitled “Actuators for Microfluidics Without Moving Parts,” issued on May 20, 2003; Kim et al., U.S. Patent Pub. No. 20030205632, entitled “Electrowetting-driven Micropumping,” published on Nov. 6, 2003; Kim et al., U.S. Patent Pub. No. 20060164490, entitled “Method and Apparatus for Promoting the Complete Transfer of Liquid Drops from a Nozzle,” published on Jul. 27, 2006; Kim et al., U.S. Patent Pub. No. 20070023292, entitled “Small Object Moving on Printed Circuit Board,” published on Feb. 1, 2007; Shah et al., U.S. Patent Pub. No. 20090283407, entitled “Method for Using Magnetic Particles in Droplet Microfluidics,” published on Nov. 19, 2009; Kim et al., U.S. Patent Pub. No. 20100096266, entitled “Method and Apparatus for Real-time Feedback Control of Electrical Manipulation of Droplets on Chip,” published on Apr. 22, 2010; Velev, U.S. Pat. No. 7,547,380, entitled “Droplet Transportation Devices and Methods Having a Fluid Surface,” issued on Jun. 16, 2009; Sterling et al., U.S. Pat. No. 7,163,612, entitled “Method, Apparatus and Article for Microfluidic Control via Electrowetting, for Chemical, Biochemical and Biological Assays and the Like,” issued on Jan. 16, 2007; Becker et al., U.S. Pat. No. 7,641,779, entitled “Method and Apparatus for Programmable Fluidic Processing,” issued on Jan. 5, 2010; Becker et al., U.S. Pat. No. 6,977,033, entitled “Method and Apparatus for Programmable Fluidic Processing,” issued on Dec. 20, 2005; Decre et al., U.S. Pat. No. 7,328,979, entitled “System for Manipulation of a Body of Fluid,” issued on Feb. 12, 2008; Yamakawa et al., U.S. Patent Pub. No. 20060039823, entitled “Chemical Analysis Apparatus,” published on Feb. 23, 2006; Wu, U.S. Patent Pub. No. 20110048951, entitled “Digital Microfluidics Based Apparatus for Heat-exchanging Chemical Processes,” published on Mar. 3, 2011; Fouillet et al., U.S. Patent Pub. No. 20090192044, entitled “Electrode Addressing Method,” published on Jul. 30, 2009; Fouillet et al., U.S. Pat. No. 7,052,244, entitled “Device for Displacement of Small Liquid Volumes Along a Micro-catenary Line by Electrostatic Forces,” issued on May 30, 2006; Marchand et al., U.S. Patent Pub. No. 20080124252, entitled “Droplet Microreactor,” published on May 29, 2008; Adachi et al., U.S. Patent Pub. No. 20090321262, entitled “Liquid Transfer Device,” published on Dec. 31, 2009; Roux et al., U.S. Patent Pub. No. 20050179746, entitled “Device for Controlling the Displacement of a Drop Between Two or Several Solid Substrates,” published on Aug. 18, 2005; and Dhindsa et al., “Virtual Electrowetting Channels: Electronic Liquid Transport with Continuous Channel Functionality,” Lab Chip, 10:832-836 (2010), the entire disclosures of which are incorporated herein by reference. Certain droplet actuators will include one or more substrates arranged with a droplet operations gap therebetween and electrodes associated with (e.g., layered on, attached to, and/or embedded in) the one or more substrates and arranged to conduct one or more droplet operations. For example, certain droplet actuators will include a base (or bottom) substrate, droplet operations electrodes associated with the substrate, one or more dielectric layers atop the substrate and/or electrodes, and optionally one or more hydrophobic layers atop the substrate, dielectric layers and/or the electrodes forming a droplet operations surface. A top substrate may also be provided, which is separated from the droplet operations surface by a gap, commonly referred to as a droplet operations gap. Various electrode arrangements on the top and/or bottom substrates are discussed in the above-referenced patents and applications and certain novel electrode arrangements are discussed in the description of the present disclosure. During droplet operations the droplets remain in continuous contact or frequent contact with a ground or reference electrode. A ground or reference electrode may be associated with the top substrate facing the gap, the bottom substrate facing the gap, in the gap. Where electrodes are provided on both substrates, electrical contacts for coupling the electrodes to a droplet actuator instrument for controlling or monitoring the electrodes may be associated with one or both plates. In some cases, electrodes on one substrate are electrically coupled to the other substrate so that only one substrate is in contact with the droplet actuator. In one embodiment, a conductive material (e.g., an epoxy, such as MASTER BOND™ Polymer System EP79, available from Master Bond, Inc., Hackensack, N.J.) provides the electrical connection between electrodes on one substrate and electrical paths on the other substrates, e.g., a ground electrode on a top substrate may be coupled to an electrical path on a bottom substrate by such a conductive material. Where multiple substrates are used, a spacer may be provided between the substrates to determine the height of the gap there between and define on-actuator dispensing reservoirs. The spacer height may, for example, be at least about 5 μm, about 100 μm, about 200 μm, about 250 μm, about 275 μm or more. Alternatively or additionally the spacer height may be at most about 600 μm, about 400 μm, about 350 μm, about 300 μm, or less. The spacer may, for example, be formed of a layer of projections form the top or bottom substrates, and/or a material inserted between the top and bottom substrates. One or more openings may be provided in the one or more substrates for forming a fluid path through which liquid may be delivered into the droplet operations gap. The one or more openings may in some cases be aligned for interaction with one or more electrodes, e.g., aligned such that liquid flowed through the opening will come into sufficient proximity with one or more droplet operations electrodes to permit a droplet operation to be effected by the droplet operations electrodes using the liquid. The base (or bottom) and top substrates may in some cases be formed as one integral component. One or more reference electrodes may be provided on the base (or bottom) and/or top substrates and/or in the gap. Examples of reference electrode arrangements are provided in the above referenced patents and patent applications. In various embodiments, the manipulation of droplets by a droplet actuator may be electrode mediated, e.g., electrowetting mediated or dielectrophoresis mediated or Coulombic force mediated. Examples of other techniques for controlling droplet operations that may be used in the droplet actuators of the present disclosure include using devices that induce hydrodynamic fluidic pressure, such as those that operate on the basis of mechanical principles (e.g. external syringe pumps, pneumatic membrane pumps, vibrating membrane pumps, vacuum devices, centrifugal forces, piezoelectric/ultrasonic pumps and acoustic forces); electrical or magnetic principles (e.g. electroosmotic flow, electrokinetic pumps, ferrofluidic plugs, electrohydrodynamic pumps, attraction or repulsion using magnetic forces and magnetohydrodynamic pumps); thermodynamic principles (e.g. gas bubble generation/phase-change-induced volume expansion); other kinds of surface-wetting principles (e.g. electrowetting, and optoelectrowetting, as well as chemically, thermally, structurally and radioactively induced surface-tension gradients); gravity; surface tension (e.g., capillary action); electrostatic forces (e.g., electroosmotic flow); centrifugal flow (substrate disposed on a compact disc and rotated); magnetic forces (e.g., oscillating ions causes flow); magnetohydrodynamic forces; and vacuum or pressure differential. In certain embodiments, combinations of two or more of the foregoing techniques may be employed to conduct a droplet operation in a droplet actuator of the present disclosure. Similarly, one or more of the foregoing may be used to deliver liquid into a droplet operations gap, e.g., from a reservoir in another device or from an external reservoir of the droplet actuator (e.g., a reservoir associated with a droplet actuator substrate and a flow path from the reservoir into the droplet operations gap). Droplet operations surfaces of certain droplet actuators of the present disclosure may be made from hydrophobic materials or may be coated or treated to make them hydrophobic. For example, in some cases some portion or all of the droplet operations surfaces may be derivatized with low surface-energy materials or chemistries, e.g., by deposition or using in situ synthesis using compounds such as poly- or per-fluorinated compounds in solution or polymerizable monomers. Examples include TEFLON® AF (available from DuPont, Wilmington, Del.), members of the cytop family of materials, coatings in the FLUOROPEL® family of hydrophobic and superhydrophobic coatings (available from Cytonix Corporation, Beltsville, Md.), silane coatings, fluorosilane coatings, hydrophobic phosphonate derivatives (e.g., those sold by Aculon, Inc), and NOVEC™ electronic coatings (available from 3M Company, St. Paul, Minn.), other fluorinated monomers for plasma-enhanced chemical vapor deposition (PECVD), and organosiloxane (e.g., SiOC) for PECVD. In some cases, the droplet operations surface may include a hydrophobic coating having a thickness ranging from about 10 nm to about 1,000 nm. Moreover, in some embodiments, the top substrate of the droplet actuator includes an electrically conducting organic polymer, which is then coated with a hydrophobic coating or otherwise treated to make the droplet operations surface hydrophobic. For example, the electrically conducting organic polymer that is deposited onto a plastic substrate may be poly(3,4-ethylenedioxythiophene) poly(styrenesulfonate) (PEDOT:PSS). Other examples of electrically conducting organic polymers and alternative conductive layers are described in Pollack et al., International Patent Pub. No. WO/2011/002957, entitled “Droplet Actuator Devices and Methods,” published on Jan. 6, 2011, the entire disclosure of which is incorporated herein by reference. One or both substrates may be fabricated using a printed circuit board (PCB), glass, indium tin oxide (ITO)-coated glass, and/or semiconductor materials as the substrate. When the substrate is ITO-coated glass, the ITO coating may be a thickness of at least about 20 nm, 50 nm, 75 nm, 100 nm or more. Alternatively or additionally the thickness can be at most about 200 nm, 150 nm, 125 nm or less. In some cases, the top and/or bottom substrate includes a PCB substrate that is coated with a dielectric, such as a polyimide dielectric, which may in some cases also be coated or otherwise treated to make the droplet operations surface hydrophobic. When the substrate includes a PCB, the following materials are examples of suitable materials: MITSUI™ BN-300 (available from MITSUI Chemicals America, Inc., San Jose Calif.); ARLON™ 11N (available from Arlon, Inc, Santa Ana, Calif.); NELCO® N4000-6 and N5000-30/32 (available from Park Electrochemical Corp., Melville, N.Y.); ISOLA™ FR406 (available from Isola Group, Chandler, Ariz.), especially IS620; fluoropolymer family (suitable for fluorescence detection since it has low background fluorescence); polyimide family; polyester; polyethylene naphthalate; polycarbonate; polyetheretherketone; liquid crystal polymer; cyclo-olefin copolymer (COC); cyclo-olefin polymer (COP); aramid; THERMOUNT® nonwoven aramid reinforcement (available from DuPont, Wilmington, Del.); NOMEX® brand fiber (available from DuPont, Wilmington, Del.); and paper. Various materials are also suitable for use as the dielectric component of the substrate. Examples include: vapor deposited dielectric, such as PARYLENE™ C (especially on glass), PARYLENE™ N, and PARYLENE™ HT (for high temperature, ˜300° C.) (available from Parylene Coating Services, Inc., Katy, Tex.); TEFLON® AF coatings; cytop; soldermasks, such as liquid photoimageable soldermasks (e.g., on PCB) like TAIYO™ PSR4000 series, TAIYO™ PSR and AUS series (available from Taiyo America, Inc. Carson City, Nev.) (good thermal characteristics for applications involving thermal control), and PROBIMER™ 8165 (good thermal characteristics for applications involving thermal control (available from Huntsman Advanced Materials Americas Inc., Los Angeles, Calif.); dry film soldermask, such as those in the VACREL® dry film soldermask line (available from DuPont, Wilmington, Del.); film dielectrics, such as polyimide film (e.g., KAPTON® polyimide film, available from DuPont, Wilmington, Del.), polyethylene, and fluoropolymers (e.g., FEP), polytetrafluoroethylene; polyester; polyethylene naphthalate; cyclo-olefin copolymer (COC); cyclo-olefin polymer (COP); any other PCB substrate material listed above; black matrix resin; polypropylene; and black flexible circuit materials, such as DuPont™ Pyralux® HXC and DuPont™ Kapton® MBC (available from DuPont, Wilmington, Del.). Droplet transport voltage and frequency may be selected for performance with reagents used in specific assay protocols. Design parameters may be varied, e.g., number and placement of on-actuator reservoirs, number of independent electrode connections, size (volume) of different reservoirs, placement of magnets/bead washing zones, electrode size, inter-electrode pitch, and gap height (between top and bottom substrates) may be varied for use with specific reagents, protocols, droplet volumes, etc. In some cases, a substrate of the present disclosure may be derivatized with low surface-energy materials or chemistries, e.g., using deposition or in situ synthesis using poly- or per-fluorinated compounds in solution or polymerizable monomers. Examples include TEFLON® AF coatings and FLUOROPEL® coatings for dip or spray coating, other fluorinated monomers for plasma-enhanced chemical vapor deposition (PECVD), and organosiloxane (e.g., SiOC) for PECVD. Additionally, in some cases, some portion or all of the droplet operations surface may be coated with a substance for reducing background noise, such as background fluorescence from a PCB substrate. For example, the noise-reducing coating may include a black matrix resin, such as the black matrix resins available from Toray industries, Inc., Japan. Electrodes of a droplet actuator may be controlled by a controller or a processor, which is itself provided as part of a system, which may include processing functions as well as data and software storage and input and output capabilities. Reagents may be provided on the droplet actuator in the droplet operations gap or in a reservoir fluidly coupled to the droplet operations gap. The reagents may be in liquid form, e.g., droplets, or they may be provided in a reconstitutable form in the droplet operations gap or in a reservoir fluidly coupled to the droplet operations gap. Reconstitutable reagents may be combined with liquids for reconstitution. An example of reconstitutable reagents suitable for use with the methods and apparatus set forth herein includes those described in Meathrel et al., U.S. Pat. No. 7,727,466, entitled “Disintegratable Films for Diagnostic Devices,” issued on Jun. 1, 2010, the entire disclosure of which is incorporated herein by reference.

“Droplet operation” means any manipulation of a droplet on a droplet actuator. A droplet operation may, for example, include: loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles. For examples of droplet operations, see the patents and patent applications cited above under the definition of “droplet actuator.” Impedance or capacitance sensing or imaging techniques may sometimes be used to determine or confirm the outcome of a droplet operation. Examples of such techniques are described in Sturmer et al., U.S. Patent Pub. No. 20100194408, entitled “Capacitance Detection in a Droplet Actuator,” published on Aug. 5, 2010, the entire disclosure of which is incorporated herein by reference. Generally speaking, the sensing or imaging techniques may be used to confirm the presence or absence of a droplet at a specific electrode. For example, the presence of a dispensed droplet at the destination electrode following a droplet dispensing operation confirms that the droplet dispensing operation was effective. Similarly, the presence of a droplet at a detection spot at an appropriate step in an assay protocol may confirm that a previous set of droplet operations has successfully produced a droplet for detection. Droplet transport time can be quite fast. For example, in various embodiments, transport of a droplet from one electrode to the next may exceed about 1 sec, or about 0.1 sec, or about 0.01 sec, or about 0.001 sec. In one embodiment, the electrode is operated in AC mode but is switched to DC mode for imaging. It is helpful for conducting droplet operations for the footprint area of droplet to be similar to electrowetting area; in other words, 1×-, 2×- 3×-droplets are usefully controlled operated using 1, 2, and 3 electrodes, respectively. By way of example, if the droplet footprint is greater than number of electrodes available for conducting a droplet operation at a given time, the difference between the droplet size and the number of electrodes should not be greater than 1; in other words, a 2× droplet is usefully controlled using 1 electrode and a 3× droplet is usefully controlled using 2 electrodes. When droplets include beads, it is useful for droplet size to be equal to the number of electrodes controlling the droplet, e.g., transporting the droplet.

“Droplet operations electrode” means one or more electrodes, utilized during a droplet operation, to provide any manipulation of a droplet on a droplet actuator. By way of example, a droplet operations electrode may receive electrical energy in connection with various operations, such as (but not limited to) loading a droplet into the droplet actuator; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a droplet actuator; other droplet operations described herein; and/or any combination of the foregoing.

“Electrical coupling” and “electrically coupled”, as used herein, shall refer to a transfer of electrical energy between any combination of a power source, an electrode, a conductive portion of a substrate, a droplet, a conductive trace, wire, other circuit segment and the like. The term electrically coupled may be utilized in connection with direct or indirect connections and may pass through various intermediaries, such as a fluid intermediary, an air gap and the like.

“Filler fluid” means a fluid associated with a droplet operations substrate of a droplet actuator, which fluid is sufficiently immiscible with a droplet phase to render the droplet phase subject to electrode-mediated droplet operations. For example, the droplet operations gap of a droplet actuator may be filled with a filler fluid. The filler fluid may, for example, be or include a low-viscosity oil, such as silicone oil or hexadecane filler fluid. The filler fluid may be or include a halogenated oil, such as a fluorinated or perfluorinated oil. The filler fluid may fill the entire gap of the droplet actuator or may coat one or more surfaces of the droplet actuator. Filler fluids may be conductive or non-conductive. Filler fluids may be selected to improve droplet operations and/or reduce loss of reagent or target substances from droplets, improve formation of microdroplets, reduce cross contamination between droplets, reduce contamination of droplet actuator surfaces, reduce degradation of droplet actuator materials, etc. For example, filler fluids may be selected for compatibility with droplet actuator materials. As an example, fluorinated filler fluids may be usefully employed with fluorinated surface coatings. Fluorinated filler fluids are useful to reduce loss of lipophilic compounds, such as umbelliferone substrates like 6-hexadecanoylamido-4-methylumbelliferone substrates (e.g., for use in Krabbe, Niemann-Pick, or other assays); other umbelliferone substrates are described in Winger et al., U.S. Patent Pub. No. 20110118132, entitled “Enzymatic Assays Using Umbelliferone Substrates with Cyclodextrins in Droplets of Oil,” published on May 19, 2011, the entire disclosure of which is incorporated herein by reference. Examples of suitable fluorinated oils include those in the Galden line, such as Galden HT170 (bp=170° C., viscosity=1.8 cSt, density=1.77), Galden HT200 (bp=200 C, viscosity=2.4 cSt, d=1.79), Galden HT230 (bp=230 C, viscosity=4.4 cSt, d=1.82) (all from Solvay Solexis); those in the Novec line, such as Novec 7500 (bp=128 C, viscosity=0.8 cSt, d=1.61), Fluorinert FC-40 (bp=155° C., viscosity=1.8 cSt, d=1.85), Fluorinert FC-43 (bp=174° C., viscosity=2.5 cSt, d=1.86) (both from 3M). In general, selection of perfluorinated filler fluids is based on kinematic viscosity (e.g., <7 cSt), and on boiling point (e.g., >150° C., for use in DNA/RNA-based applications (PCR, etc.)). Filler fluids may, for example, be joined with surfactants or other additives. For example, additives may be selected to improve droplet operations and/or reduce loss of reagent or target substances from droplets, formation of microdroplets, cross contamination between droplets, contamination of droplet actuator surfaces, degradation of droplet actuator materials, etc. Composition of the filler fluid, including surfactant doping, may be selected for performance with reagents used in the specific assay protocols and effective interaction or non-interaction with droplet actuator materials. Examples of filler fluids and filler fluid formulations suitable for use with the methods and apparatus set forth herein are provided in Srinivasan et al, International Patent Pub. No. WO/2010/027894, entitled “Droplet Actuators, Modified Fluids and Methods,” published on Jun. 3, 2010; Srinivasan et al, International Patent Pub. No. WO/2009/021173, entitled “Use of Additives for Enhancing Droplet Operations,” published on Feb. 12, 2009; Sista et al., International Patent Pub. No. WO/2008/098236, entitled “Droplet Actuator Devices and Methods Employing Magnetic Beads,” published on Jan. 15, 2009; and Monroe et al., U.S. Patent Pub. No. 20080283414, entitled “Electrowetting Devices,” published on Nov. 20, 2008, the entire disclosures of which are incorporated herein by reference, as well as the other patents and patent applications cited herein. Fluorinated oils may in some cases be doped with fluorinated surfactants, e.g., Zonyl FSO-100 (Sigma-Aldrich) and/or others. A filler fluid may be a liquid. In some embodiments, a filler gas can be used instead of a liquid.

“Reservoir” means an enclosure or partial enclosure configured for holding, storing, or supplying liquid. A droplet actuator system of the present disclosure may include on-cartridge reservoirs and/or off-cartridge reservoirs. On-cartridge reservoirs may be (1) on-actuator reservoirs, which are reservoirs in the droplet operations gap or on the droplet operations surface; (2) off-actuator reservoirs, which are reservoirs on the droplet actuator cartridge, but outside the droplet operations gap, and not in contact with the droplet operations surface; or (3) hybrid reservoirs which have on-actuator regions and off-actuator regions. An example of an off-actuator reservoir is a reservoir in the top substrate. An off-actuator reservoir is in fluid communication with an opening or flow path arranged for flowing liquid from the off-actuator reservoir into the droplet operations gap, such as into an on-actuator reservoir. An off-cartridge reservoir may be a reservoir that is not part of the droplet actuator cartridge at all, but which flows liquid to some portion of the droplet actuator cartridge. For example, an off-cartridge reservoir may be part of a system or docking station to which the droplet actuator cartridge is coupled during operation. Similarly, an off-cartridge reservoir may be a reagent storage container or syringe which is used to force fluid into an on-cartridge reservoir or into a droplet operations gap. A system using an off-cartridge reservoir may include a fluid passage means whereby liquid may be transferred from the off-cartridge reservoir into an on-cartridge reservoir or into a droplet operations gap.

The terms “top,” “bottom,” “over,” “under,” and “on” are used throughout the description with reference to the relative positions of components of the droplet actuator, such as relative positions of top and bottom substrates of the droplet actuator. It will be appreciated that the droplet actuator is functional regardless of its orientation in space.

When a liquid in any form (e.g., a droplet or a continuous body, whether moving or stationary) is described as being “on”, “at”, or “over” an electrode, array, matrix or surface, such liquid could be either in direct contact with the electrode/array/matrix/surface, or could be in contact with one or more layers or films that are interposed between the liquid and the electrode/array/matrix/surface. In one example, filler fluid can be considered as a film between such liquid and the electrode/array/matrix/surface.

When a droplet is described as being “on” or “loaded on” a droplet actuator, it should be understood that the droplet is arranged on the droplet actuator in a manner which facilitates using the droplet actuator to conduct one or more droplet operations on the droplet, the droplet is arranged on the droplet actuator in a manner which facilitates sensing of a property of or a signal from the droplet, and/or the droplet has been subjected to a droplet operation on the droplet actuator.

The terms “fluidics cartridge,” “digital fluidics cartridge,” “droplet actuator,” and “droplet actuator cartridge” as used throughout the description can be synonymous.

### SUMMARY

In accordance with embodiments herein, an electrode drive circuit is provided that comprises a droplet operations electrode and an electrowetting (EW) driver connected to the droplet operations electrode by a signal path. The EW driver is to supply an electrowetting drive signal component to the droplet operations electrode. A capacitance measurement (CM) device is connected to the droplet operations electrode by the signal path. The CM device is to sense a sensing signal component indicative of at least one of a presence or absence of a droplet at the droplet operations electrode. A first coupling circuit is positioned between the EW driver and the droplet operations electrode along the signal path. A second coupling circuit is positioned between the CM device and the same droplet operations electrode along the signal path.

Optionally, the first coupling circuit may represent a DC coupling circuit that allows both DC and AC signals to pass therethrough, while attenuating the sensing signal component from the droplet operations electrode. The second coupling circuit may represent an AC coupling circuit that may block at least a portion of the drive signal component from reaching the CM device. The signal path may carry the drive signal component and sensing signal component simultaneously and superimposed upon one another. The EW driver and CM device may alternately utilize the signal path in a time interleaved manner.

Optionally, the second coupling circuit may block at least a portion of the drive signal component having a frequency at or below a drive signal cut off frequency. The drive signal cut off frequency may be 500 Hz. The first coupling circuit may block at least a portion of the sensing signal component having a frequency at or above a sensing signal cut off frequency. The sensing signal cutoff frequency may be 5000 Hz.

In accordance with embodiments herein, an apparatus is provided that comprises a droplet actuator having first and second substrates that are separated by a droplet operations gap. A droplet operations electrode is provided on at least one of the first and second substrates and located proximate to the droplet operations gap. An electrowetting (EW) driver is connected to the droplet operations electrode by a signal path. The EW driver is to supply an electrowetting drive signal component to the droplet operations electrode. A capacitance measurement (CM) device is connected to the droplet operations electrode by a signal path. The CM device is to sense a sensing signal component indicative of at least one of a presence or absence of a droplet at the droplet operations electrode. A first coupling circuit is positioned between the EW driver and the droplet operations electrode along the signal path. A second coupling circuit is positioned between the CM device and the same droplet operations electrode along the signal path.

Optionally, the apparatus further comprises a plurality of the droplet operations electrodes having corresponding signal paths. The EW driver and CM device may be connected to the droplet operations electrodes over the corresponding signal paths. The EW driver and CM device may be connected over a common one of the signal paths with a corresponding one of the droplet operations electrodes. First and second droplet operations electrodes may have an interleaved pattern and may be arranged in a coplanar configuration. The EW driver may drive the first and second droplet operations electrodes in a common mode in connection with moving droplets. The CM device may operate the first and second droplet operations electrodes in a differential mode to generate an electric field within the droplet in connection with a sensing operation.

Optionally, a printed circuit board may include a trace that is at least partially surrounded by AC shielding traces. The trace may define the signal path to carry the drive signal component and the sensing signal component. A reference electrode may be provided along the first substrate. The droplet operations electrode may provide along the second substrate. The sensing signal may represent a plate capacitance exhibited between the reference electrode and droplet operations electrode. The plate capacitance varying based on the presence or absence of a droplet at the droplet operation gap.

In accordance with embodiments herein, a method is provided that comprises supplying an electrowetting (EW) drive signal component from an EW driver to the droplet operations electrode along a signal path. The method receives a sensing signal component from the droplet operations electrode at a capacitance measurement (CM) device along the signal path. The method determines a presence or absence of a droplet at the droplet operations electrode based on the sensing signal component. The method blocks the drive signal component from reaching the CM device along the signal path.

Optionally, the method may perform a droplet operation, utilizing the drive signal component, while determining the presence or absence of the droplet at the droplet operations electrode based on the sensing signal component. The method may further comprise at least partially attenuating the sensing signal component along an EW branch of the signal path to the EW driver. The blocking operation may be performed along a CM branch of the signal path. The determining operation may include determining when a capacitance measured at the droplet operations electrode is above or below a capacitance threshold. The determining operation may include identifying the absence of the droplet when an amount of the capacitance is below the capacitance threshold, and identifying the presence of the droplet when the amount of the capacitance is at or above the capacitance threshold.

### BRIEF DESCRIPTIONS OF THE DRAWINGS

FIG. 1 illustrates a side view of a portion of an example of a droplet actuator and wherein the electrodes have a bi-planar configuration in accordance with embodiments herein.

FIG. 2 illustrates an example of approximating the parallel plate capacitance of the electrodes in a droplet actuator in accordance with embodiments herein.

FIG. 3 illustrates a schematic diagram of an example of an electrode drive circuit that has capability of multiplexing capacitance sensing signals with drive voltages in accordance with embodiments herein.

FIG. 4A illustrates a perspective view of an example of shielding configuration for shielding the capacitance sensing signals of the electrode drive circuit of FIG. 3 in accordance with embodiments herein.

FIG. 4B shows an example of a plot of the simulation of the effectiveness of the shielding configuration of FIG. 4A in accordance with embodiments herein.

FIG. 5 illustrates a flow diagram of an example of a method of using the electrode drive circuit of FIG. 3 to both drive electrodes and to sense the presence and/or absence of droplets at electrodes in accordance with embodiments herein.

FIG. 6 illustrates a schematic diagram of an example of using the electrode drive circuit of FIG. 3 to perform fluid level and/or area sensing in a droplet actuator in accordance with embodiments herein.

FIG. 7 illustrates a schematic diagram of another example of an electrode drive circuit that has capability of multiplexing capacitance sensing signals with drive voltages and wherein the electrodes have a coplanar configuration in accordance with embodiments herein.

FIG. 8 illustrates a block diagram of an example of a microfluidics system that includes a droplet actuator in accordance with embodiments herein.

### DETAILED DESCRIPTION

Embodiments herein describe electrode drive circuits of a droplet actuator for and methods of multiplexing capacitance sensing signals with drive voltages, wherein capacitance sensing is used to sense the presence and/or absence of droplets at the droplet operations electrodes. Namely, the electrode drive circuits include (1) an electrowetting driver for driving the electrowetting voltage of a droplet actuator and (2) a capacitance measurement circuit for sensing the presence and/or absence of droplets at the droplet operations electrodes. DC coupling (e.g., resistors) is used to connect the electrowetting driver to the droplet operations electrodes; and AC coupling (e.g., capacitors) is used to connect the capacitance measurement circuit to the same droplet operations electrodes.

Embodiments of the electrode drive circuits and methods use a common electrical connection to both drive an electrowetting voltage (via the electrowetting driver) and to sense the presence and/or absence of a droplet at the droplet operations electrode (via the capacitance measurement circuit). An aspect of the capacitance measurement circuit is that it uses capacitively coupling sensing and/or shielding signals to enable a single line or trace to be used for both driving the electrowetting voltage and sensing the presence and/or absence of a droplet.

In some embodiments, the droplet operations electrodes that are being both driven and sensed using the presently disclosed electrode drive circuits are in a bi-planar configuration. However, in other embodiments, the droplet operations electrodes that are being both driven and sensed using the presently disclosed electrode drive circuits are in a coplanar configuration.

In yet other embodiments, the electrode drive circuits and methods can be used to perform fluid level and/or area sensing in a droplet actuator.

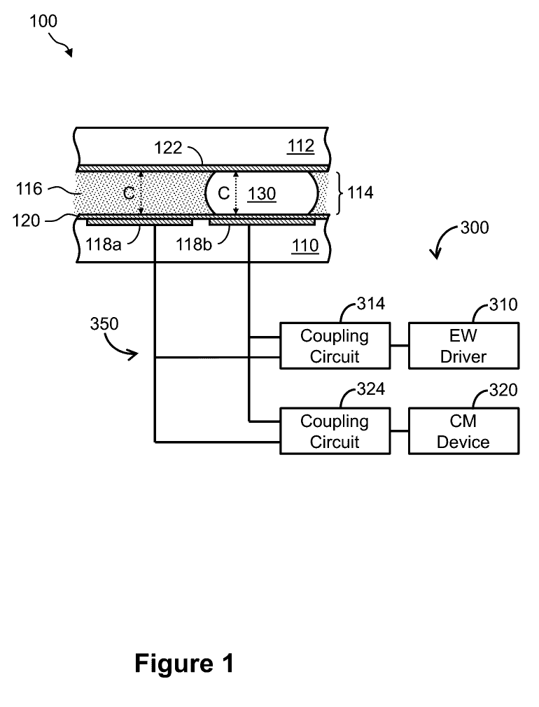

FIG. 1 illustrates a side view of a portion of an example of a droplet actuator 100 and wherein the electrodes have a bi-planar configuration. Droplet actuator 100 is one example of a fluidics cartridge. Droplet actuator 100 includes a bottom substrate 110 and a top substrate 112 that are separated by a droplet operations gap 114. Droplet operations gap 114 contains filler fluid 116. The filler fluid 116 is, for example, low-viscosity oil, such as silicone oil or hexadecane filler fluid. Bottom substrate 110 can be, for example, a printed circuit board (PCB) that may include an arrangement of droplet operations electrodes 118 (e.g., electrowetting electrodes). Additionally, an insulating layer 120 may be provided atop droplet operations electrodes 118. Top substrate 112 can be, for example, a plastic or glass substrate. Top substrate 112 may include a reference electrode plane 122 that can be formed, for example, of conductive ink or indium tin oxide (ITO). FIG. 1 shows a droplet 130 in droplet operations gap 114. Droplet 130 can be, for example, a reagent droplet. Droplet operations are conducted atop droplet operations electrodes 118 on a droplet operations surface.

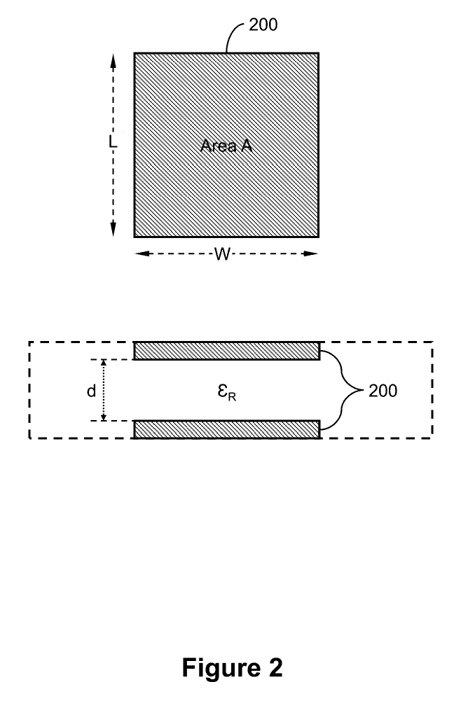

A certain amount of capacitance C is present between two parallel plates, such as between any one droplet operations electrode 118 and reference electrode plane 122. The amount of capacitance C depends on the distance and the material between the two parallel plates; namely, the distance between the parallel plates and the relative permittivity ε_{R} of the material between the plates. FIG. 2 illustrates an example of approximating the parallel plate capacitance C of the electrodes in a droplet actuator. For example, FIG. 2 shows two parallel plates 200 that have a certain area A (i.e., length L×width W) and that are a certain distance d apart. Namely, the parallel plate capacitance C can be approximated by (ε₀×ε_{R}×A)÷d, where ε₀ is the permittivity of free space, ε_{R} is the relative permittivity of the material/fluid in the gap, A is the area (length L×width W) of the plates, and d is the distance between the plates.

Referring now again to droplet actuator 100 of FIG. 1, filler fluid 116 (e.g., silicone oil) alone may have a relative permittivity ε_{R} of about less than 3. Further, filler fluid 116 together with insulating layer 120 may have a total relative permittivity ε_{R} of up to about 4. Accordingly, at droplet operations electrode 118A, upon which there is no droplet present, the relative permittivity ε_{R} of the material between droplet operations electrode 118A and reference electrode plane 122 can be from about 3 to about 4. By contrast, the relative permittivity ε_{R} of droplet 130 (e.g., reagent droplet) can be, for example, from about 30 to about 80. Accordingly, at droplet operations electrode 118B, upon which droplet 130 is present, the relative permittivity ε_{R} of the material between droplet operations electrode 118B and reference electrode plane 122 can be about an order of magnitude greater than the relative permittivity ε_{R} at droplet operations electrode 118A, which has no droplet present.

Therefore, according to the parallel plate capacitance C approximated by (ε₀×ε_{R}×A)÷d, the parallel plate capacitance C at a droplet operations electrode 118 that has a droplet present can be an order of magnitude greater than that at a droplet operations electrode 118 without a droplet present. This difference in parallel plate capacitance C between a droplet being present at a certain droplet operations electrode 118 as compared with a droplet being absent at the same droplet operations electrode 118 is measurable using the presently disclosed electrode drive circuits and methods as described herein below.

FIG. 1 also illustrates a block diagram of an electrode drive circuit 300 coupled to the droplet actuator 100. The electrode drive circuit 300 includes an electrowetting (EW) driver 310 is connected to the droplet operations electrodes 118a, 118b (collectively 118) by a signal path 350. The EW driver 310 supplies electrowetting drive signal components to the corresponding droplet operations electrode 118a, 118b. A capacitance measurement (CM) device 320 is connected to the droplet operations electrodes 118a, 118b by corresponding signal paths 350. The CM device 320 senses sensing signal components indicative of at least one of a presence or absence of a droplet at the corresponding droplet operations electrode 118a, 118b. A first coupling circuit 314 is positioned between the EW driver 310 and the droplet operations electrodes 118a, 118b along the corresponding signal paths 350. A second coupling circuit 324 is positioned between the CM device 320 and the same droplet operations electrodes 118a, 118b along the corresponding signal paths 350. The operation of the EW driver 310, CM device 320, and coupling circuits 314, 324 is described herein in more detail.

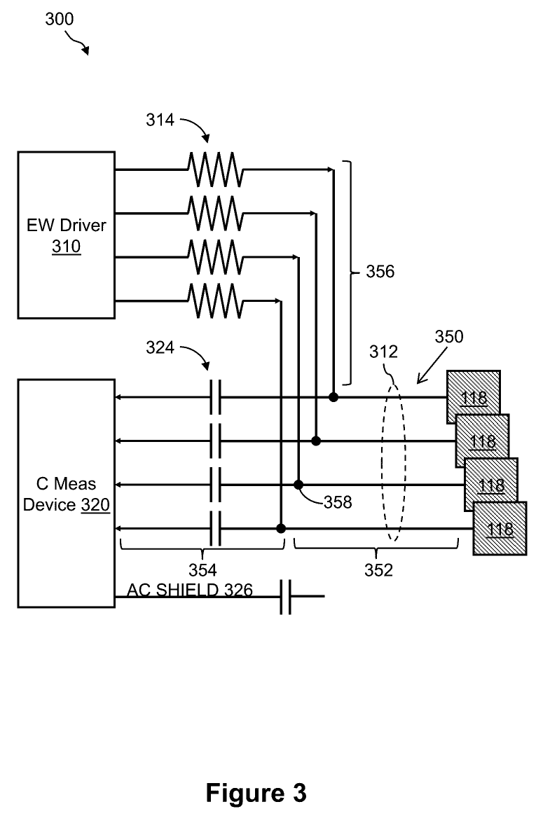

FIG. 3 illustrates a schematic diagram of the electrode drive circuit 300 of FIG. 1 that has a capability of multiplexing capacitance sensing signals with drive voltages for the purpose of sensing droplets. For example, electrode drive circuit 300 includes an electrowetting (EW) driver 310 and a capacitance measurement circuit or device 320. By way of example, electrode drive circuit 300 shown in FIG. 3 supports four droplet actuator channels, such as four droplet operations electrodes 118 of droplet actuator 100 of FIG. 1. However, this is exemplary only. Electrode drive circuit 300 can be used to support any number of droplet actuator channels (i.e., channels 1-n).

Electrode drive circuit 300 uses a common electrical connection to both drive the EW voltage (via EW driver 310) and to sense the presence and/or absence of a droplet at the droplet operations electrode (via capacitance measurement device 320).

In electrode drive circuit 300, EW driver 310 is a multichannel, high voltage, low current driver. The EW driver 310 is connected to each of the droplet operations electrode 118 by a corresponding signal path 350, which corresponds to a channel. The signal paths 350 may be defined by traces on a PCB, lines or any other conductive medium. The EW driver 310 is to supply an electrowetting drive signal component to the droplet operations electrodes 118 over corresponding signal paths 350. For example, EW driver 310 is capable of supplying an EW voltage of up to about 300 VDC (or 300 VAC, e.g., drive voltage swings 300V above and below ground) at a current up to several milliamps. An example of EW driver 310 is the HV507 device available from Microchip Technology (Chandler, Ariz.). The HV507 is a 64-bit serial-in/parallel-out shift register with 64 high voltage outputs.

A first coupling circuit 314 (e.g., a coupling resistor) is positioned between the EW driver 310 and the droplet operations electrodes 118 along the corresponding signal paths 350. In the embodiment of FIG. 3, the first coupling circuits represent DC coupling circuits (resistors) 314 that allow both DC and AC signals to pass there through, while at least partially attenuating capacitive sensing signal components from the droplet operations electrodes which occur during a capacitive measurement operation. The first coupling circuit 314 may block at least a portion of the capacitive sensing signal component having a frequency at or above a sensing signal cut off frequency. As one example, the sensing signal cut off frequency may be set at 5000 Hz. Optionally, the sensing signal cut off frequency may be set higher or lower, such as at 2000 Hz or 10,000 Hz.

Electrowetting drive signals operate at low frequencies, for example between DC and 1 kHz. Therefore, DC coupling (e.g., current-limiting resistors) can be used to connect EW driver 310 to droplet operations electrodes 118. For example, the PCB traces 312 connecting to droplet operations electrodes 118 are connected through resistors 314 to the outputs of EW driver 310. The coupling resistors 314 have a high resistance, such as greater than 100 kohm. During droplet operations, PCB traces 312 are used as signal paths for voltage drive lines. Each of the traces 312 defined a signal path, generally denoted at 350. Each signal path 350 includes a common branch portion 352, an EW branch 356 and a CM branch 354. The common branch portion 352 of the signal path 350 carries both EW drive signal components from the EW driver 310 and capacitance sensing signal components returned to the CM device 320. Each signal path 350 includes a branch node 358 at which the EW and CM branches 356 and 354 diverge from the common branch portion 352. The EW driver signal component and the capacitive sensing signal may be carried by a common signal path simultaneously and superimposed upon one another. Optionally, the EW driver signal component and the capacitive sensing signal may be carried by a common signal path, but temporally at different points in time, such as in a time interleaved manner when droplet movement operations are performed intermittently with droplet position sensing operations.

The CM circuit or device 320 is connected to corresponding droplet operations electrodes 318 by associated signal paths 350. The CM device 320 is to sense a capacitive sensing signal component indicative of at least one of a presence or absence of a droplet at the corresponding droplet operations electrode. A second coupling circuit (corresponding to coupling capacitors 324) is positioned between the CM device 320 and the same corresponding droplet operations electrodes 118 along the signal paths 350. In accordance with at least one embodiment, the second coupling circuit corresponds to coupling capacitors 324 that represent AC coupling circuits that block at least a portion of the EW drive signal component from reaching the CM device 320. The second coupling circuits may block at least a portion of the drive signal component having a frequency at or below a drive signal cut off frequency. As one example, the drive signal cutoff frequency may be set at 500 Hz, such that drive signal components having a frequency at or below 500 Hz are blocked along the CM branch 354 and prevented from reaching the CM device 320. Optionally, the drive signal cutoff frequency may be set at a lower cutoff frequency, such as 100 Hz. Alternatively, the drive signal cutoff frequency may be set at a higher frequency, such as 1000 Hz.

Capacitive sensing devices may employ signals above 10 kHz. Therefore, AC coupling (e.g., capacitors) can be used to connect capacitance measurement circuit or device 320 to the same droplet operations electrodes 118. For example, the PCB traces 312 connecting to droplet operations electrodes 118 are connected through capacitors 324 to the inputs of capacitance measurement device 320. The coupling capacitors 324 are small capacitors, such as about 150 pF or less. During droplet sensing operations, PCB traces 312 are used as sense lines. Namely, because the two functions (EW driving and droplet sensing) use different regions in the frequency spectrum, the two functions may be multiplexed onto the same droplet operations electrodes 118 using capacitors 324 to couple the sensing signals and resistors 314 to couple the drive voltages.

Droplet sensing according to embodiments herein relies on accurately measuring/detecting small changes (e.g., possibly sub-pico farad) in capacitance depending on whether a droplet is present in/near the region between the sense electrode (which could also be a drive electrode) and the reference electrode (which could be the top plate, another multiplexed drive electrode, or a dedicated reference electrode).

A feature of capacitance measurement device 320 is that it uses capacitively coupling sensing and/or shielding signals to enable a single line or trace to be used for both driving the electrowetting voltage and sensing the presence and/or absence of a droplet. In one example, capacitance measurement device 320 is the AD7147 device available from Analog Devices (Norwood, Mass.). The AD7147 is a 13-channel capacitance-to-digital converter (CDC) for capacitive sensing. In another example, capacitance measurement device 320 is the FDC1004 device available from Texas Instruments (Dallas, Tex.). The FDC1004 is a 4-channel CDC for capacitive sensing.

For improved accuracy, it may be beneficial to provide shielding of the connecting trace between capacitance measurement device 320 and the electrode sensing the droplet. Both the AD7147 and the FDC1004 support an AC shield that can be used to shield the sensing signals to support the sensing electrodes being located far from the capacitance measurement device 320. For example, capacitance measurement device 320 has an AC SHIELD 326 output that can be used for shielding the sensing signals (e.g., PCB traces 312). In the present example, the AC SHIELD 326 is illustrated as a capacitor, although additional and/or alternative components may be utilized to provide AC shielding. Optionally, the AC SHIELD 326 may be omitted entirely. In accordance with at least one embodiment, the printed circuit board includes a plurality of traces 312 that carry the EW drive signal components and capacitive sensing signal components, where at least a portion of the traces 312 are fully or partially surrounded with shielding. For example, one or more of the traces 312 may be individually at least partially surrounded by AC shielding traces.

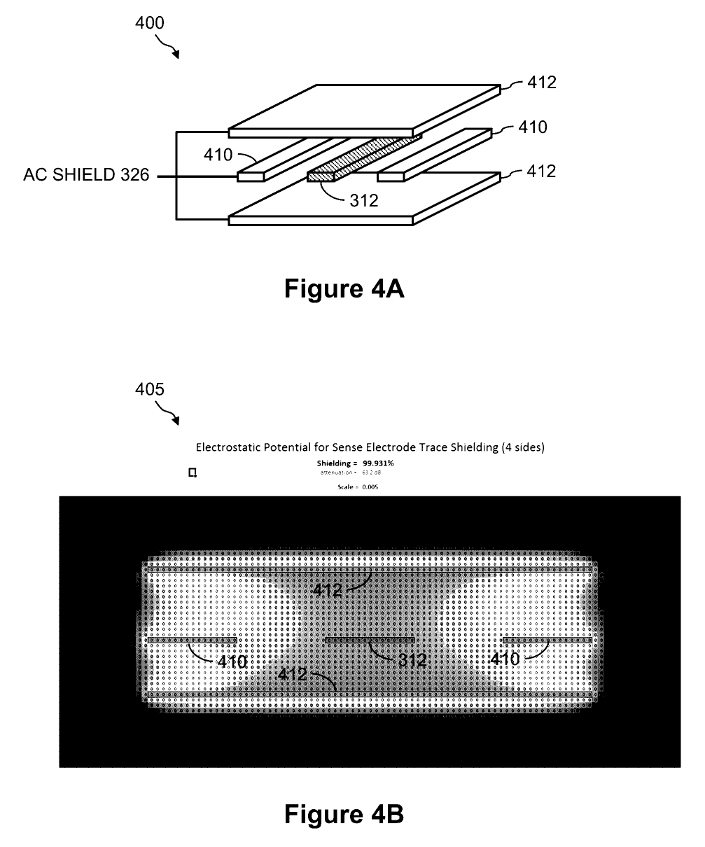

FIG. 4A shows a perspective view of an example of shielding configuration 400 for shielding the capacitance sensing signals (e.g., PCB traces 312) of electrode drive circuit 300 of FIG. 3. In shielding configuration 400, each individual PCB trace 312 is flanked on both sides by a pair of narrow shielding traces 410 that are connected to AC SHIELD 326 of capacitance measurement device 320. Further, in shielding configuration 400, each individual PCB trace 312 is flanked top and bottom by a pair of wide shielding traces 412 that are also connected to AC SHIELD 326 of capacitance measurement device 320. Using shielding configuration 400, each PCB trace 312 can be protected from external fields. The efficacy of shielding configuration 400 may be affected by adjusting the cross sectional area of the shielding traces and/or adjusting the spacing between all elements. FIG. 4B shows an example of a plot 405 of the simulation of the effectiveness of shielding configuration 400 of FIG. 4A. As shown in plot 405, the shielding traces 410, 412 pin the external electric field (with the region denoted by dashed lines 415) and prevent the electrical field from reaching the sensing trace, e.g., PCB trace 312. In shielding configuration 400, the shield may be effective at blocking over about 99.9% of external fields from the sensing trace.

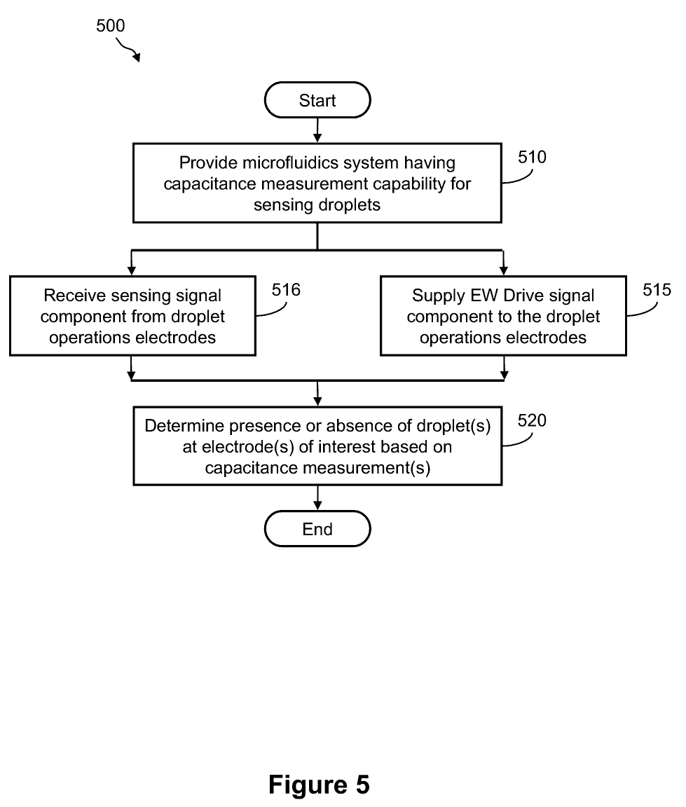

FIG. 5 illustrates a flow diagram of an example of a method 500 of using electrode drive circuit 300 of FIG. 3 to both drive electrodes and to sense the presence and/or absence of droplets at electrodes. Method 500 may include, but is not limited to, the following steps.

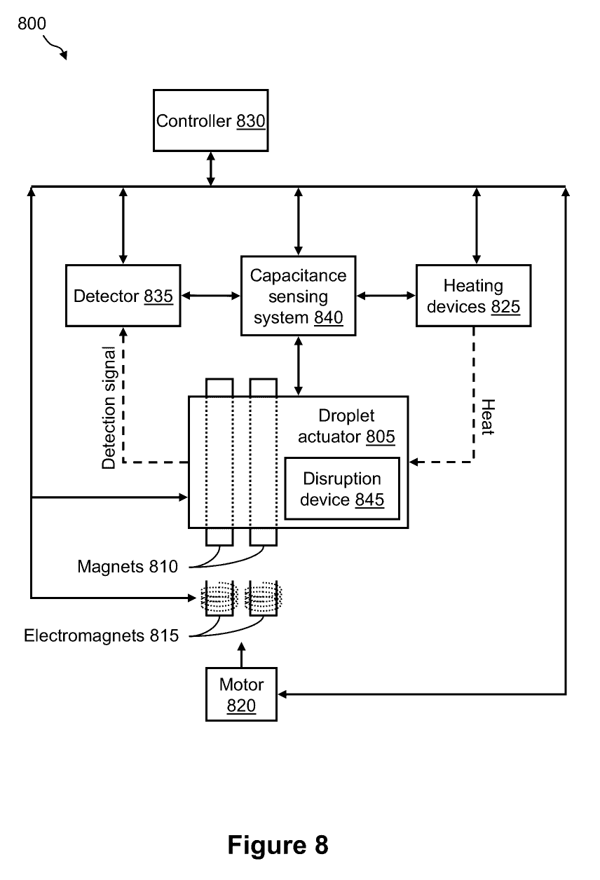

At a step 510, a microfluidics system (see FIG. 8) is provided that has capacitance measurement capability for sensing droplets. For example, a microfluidics system is provided that includes electrode drive circuit 300 of FIG. 3, wherein electrode drive circuit 300 includes capacitance measurement device 320 in combination with EW driver 310. Further, the capacitance measurement capability of electrode drive circuit 300 is used for sensing droplets in a digital fluidics cartridge, such as droplet actuator 100 of FIG. 1.

At steps 515 and 516, droplet operations are performed in a digital fluidics cartridge, while at the same time the capacitance at certain electrode(s) of interest is monitored for the purpose of sensing droplets. As one example, at 515, and need to be drive signal component is supplied from a need to be driver to the droplet operations electrode along a signal path. At the same time, at 516, a sensing signal component is received from the droplet operations electrode at the CM device along the signal path. While in the present example, the operations at 515 and 516 are performed simultaneously and in parallel, alternatively, the operations at 515 and 516 may be performed in series and in an alternating manner.

For example, using electrode drive circuit 300 of FIG. 3 in combination with droplet actuator 100 of FIG. 1, droplet operations are performed atop droplet operations electrodes 118 of droplet actuator 100 using EW driver 310. For example, based on directions from a processor (of the controller), the EW driver 310 supplies EW drive signals that cause the droplet 132B transported via droplet operations along droplet operations electrodes 118. For example, the EW drive signal component is supplied from the EW driver to the droplet operations electrode along the corresponding signal path to cause a desired droplet operation, namely move a droplet away from a corresponding electrode, move a droplet toward a corresponding electrode, split a droplet into two separate droplets, etc.

At 516, the processor (of the controller) also directs the capacitance measurement device 320 to perform a capacitance reading, for example, at droplet operations electrode 118A at a time in which there is no droplet present thereon. For example, the CM device 320 may generate a voltage potential between the reference electrode and a corresponding droplet operations electrode, and in connection there with receive a sensing signal component from the droplet operations electrode along the corresponding signal path. Further, using capacitance measurement device 320, a capacitance reading is captured, for example, at droplet operations electrode 118B at a time in which droplet 130 is present thereon.

At a step 520, the presence or absence of droplet(s) at electrode(s) of interest is determined by the CM device and/or processor, based on capacitance measurement(s). More specifically, the CM device 320 determines a presence or absence of a droplet at the droplet operations electrode based on the capacitive sensing signal component. For example, a certain lower capacitance reading at droplet operations electrode 118A at a time in which there is no droplet present thereon indicates the absence of a droplet at droplet operations electrode 118A. By contrast, a certain higher capacitance reading captured at droplet operations electrode 118B at a time in which droplet 130 is present thereon indicates the presence of a droplet at droplet operations electrode 118A. By way of example, the CM circuit 320 may determine when a capacitance measured at the droplet operations electrode is above or below a capacitance threshold. The CM device 320 identifies the absence of a droplet at the droplet operations electrode when the amount of capacitance measured is below the capacitance threshold. The CM device 320 identifies the presence of a droplet at the droplet operations electrode when the amount of capacitance measured is at or above the capacitance threshold.

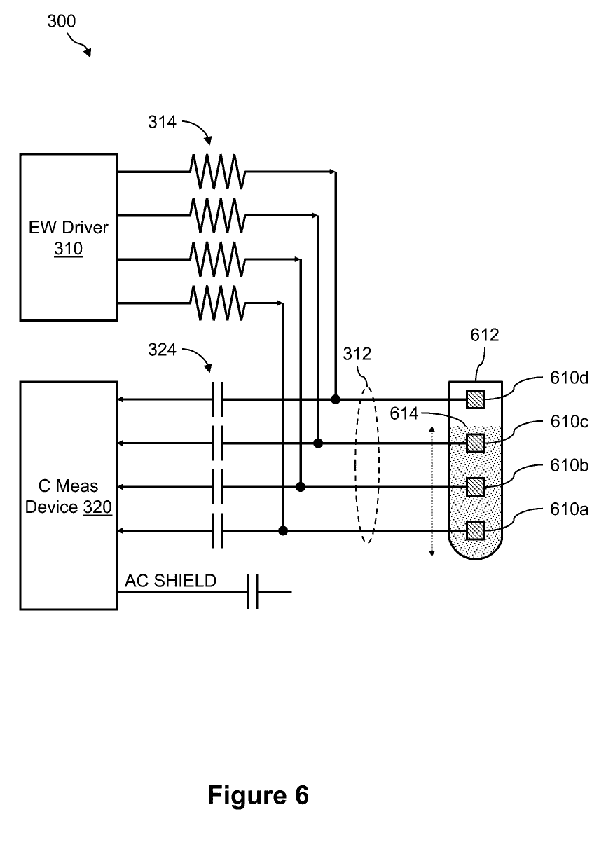

FIG. 6 illustrates a schematic diagram of an example of using electrode drive circuit 300 of FIG. 3 to perform fluid level and/or fluid area sensing in a droplet actuator. In one example, a vertical stack of electrodes 610 is provided within a well (or reservoir) 612, wherein well 612 can be used to collect any type of liquid, such as reagent solution 614. Electrodes 610 are electrically coupled to both EW driver 310 and capacitance measurement device 320 of electrode drive circuit 300 as described with reference to FIG. 3. In the case of fluid level sensing, as the level of reagent solution 614 rises within well 612, the capacitance readings from the individual electrodes 610 indicate the absence or presence of reagent solution 614 at a given electrode 610 along the vertical stack. For fluid area sensing, electrodes 610 can be arranged over an area of a horizontal plane and capacitance readings from the individual electrodes 610 indicate the absence or presence of reagent solution 614 at a given area of the plane.

FIG. 6 also illustrates an AC SHIELD line with a capacitor as the shielding component. Additional and/or alternative components may be utilized to provide AC shielding. Optionally, the AC SHIELD may be omitted entirely.

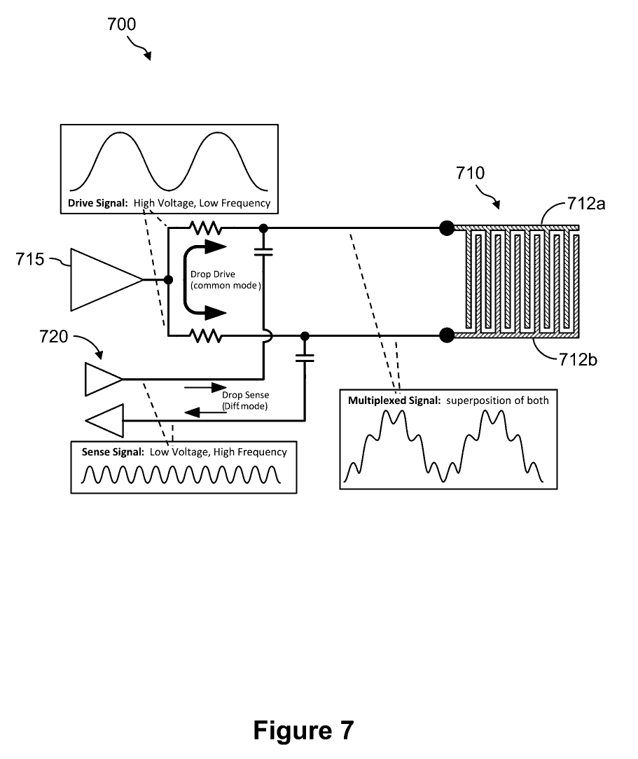

FIG. 7 illustrates a schematic diagram of another example of an electrode drive circuit 700 that has capability of multiplexing capacitance sensing signals with drive voltages and wherein the electrodes have a coplanar configuration. In this example, electrode drive circuit 700 is used in combination with an electrode arrangement 710. Namely, electrode arrangement 710 includes a pair of interleaved droplet operations electrodes 712 (e.g., interleaved droplet operations electrodes 712a, 712b), wherein interleaved droplet operations electrodes 712a, 712b are coplanar. The term “interleaved” is used to refer to a pattern in which the electrodes are positioned in an alternating arrangement.

In electrode drive circuit 700, interleaved droplet operations electrodes 712a, 712b are used for both driving the droplets and detecting droplets capacitively. Two interleaved droplet operations electrodes 712a, 712b (either castellated, spiraled, or concentric rings) can be driven together in common mode to act as one electrode for moving droplets. Further, the same two electrodes can be driven (with appropriate electrical coupling) in differential mode to generate an electric field within the droplet for sensing. For example, first and second droplet operations electrodes 712a, 712b (that have the interleaved pattern and are arrange in a coplanar configuration) may be driven in different modes during the EW driver operations NCM measurement operations. For example, the EW driver 310 may drive the first and second droplet operations electrodes in a common mode in connection with moving droplets. The CM circuit may operate the first and second droplet operations electrodes in a differential mode to generate an electric field within the droplet in connection with a sensing operation for sensing the position of a droplet.

Electrode drive circuit 700 includes EW driver 715 and capacitance measurement device 720. Electrowetting can function at very low frequencies (DC to a few 10 s of Hertz), but for capacitive sensing higher frequencies (10 KHz or more) are used since the capacitances being measured for drop detection are generally very small (a few picofarads or less). This means the driving signal (100 s of volts) may be DC coupled to both electrodes (generally through a resistance of about 1 Mohm), and the sensing signals may be AC coupled to those same electrodes through inexpensive capacitors.

In a coplanar electrowetting system, the sensing electrode pair may act as a single drive electrode by being driven together with the same drive voltage. By contrast, in a bi-planar electrowetting system (e.g., droplet actuator 100 of FIG. 1), the sensing electrode pair may be driven with the same driving voltage as the reference plane so that, to the droplets, the sensing electrode pair will appear to be a continuous part of the reference plane.

Because the capacitance of the droplets is very small, the capacitance of the sense AC coupling capacitors may be chosen to be low enough to minimize low frequency loading of the electrodes and not adversely impact the rise/fall time of the driving voltage at the electrodes. Selecting capacitors rated for high voltages allows sensing to occur on the high voltage drive electrodes without risking damage to the low voltage sensing components. Further, in some cases it may be prudent to add additional protection devices, such as low capacitance clamping diodes.

Testing may determine that the drive voltage interferes with the sensing function. In this case, sensing may be synchronized with the drive voltage so that the interference will be either predictable or negligible.

A castellated interleaved electrode is shown in FIG. 7, but in practice any capacitively coupled electrodes could work whether they are coplanar, bi-planar, or even if one electrode is not really an electrode at all (a grounded piece of nearby sheet metal for instance). This method could apply to other variations on capacitive sensing (differential capacitive sensing for instance), so this drive/sense multiplexing could be applied to more than just two electrodes.

The embodiment described in connection with FIG. 7 applies to a coplanar configuration, in which the two interleaved droplet operations electrodes 712a, 712b are coplanar. By way of example, the droplet operations electrode 712a include a plurality of fingers or traces that extend parallel to one another. The droplet operations electrode 712b also include a plurality of fingers or traces that extend parallel to one another. The fingers of the droplet operations electrodes 712a, 712b face one another and are aligned to fit between one another in an interleaved manner. While not illustrated in FIG. 7, it is understood that a parallel reference plane electrode is provided such as electrode 122 in FIG. 1. The droplet operations electrodes 712a, 712b and reference plane electrode are utilized to move the droplet. For example, the parallel plane electrode may be maintained at a reference voltage for electrowetting operations. During droplet operations, the EW driver 310 (FIG. 3) may simultaneously provide a common mode drive signal to the droplet operations electrodes 712a, 712b. When the droplet operations electrodes 712a, 712b are driven with a common mode electrowetting drive signal (i.e. a high voltage signal applied equally to both electrodes), the droplet operations electrodes 712a, 712b have the same voltage potential (relative to a reference voltage) and act as a single “composite” drive electrode. An electric field is created between the “composite” drive electrodes 712a, 712b and the reference plane electrode (e.g., 122) to move the droplet and perform other droplet operations.

During sensing operations, the CM device 320 (FIG. 3) may provide a differential signal to the droplet operations electrodes 712a, 712b, in which the droplet operations electrode 712a has a different voltage than the droplet operations electrode 712b. When a differential signal is applied, the differential signal has a smaller and higher frequency as compared to the common mode signal. When the differential signal is applied, the droplet operations electrodes 712a, 712b receive different voltages (relative to one another), thereby creating a voltage potential change between the droplet operations electrodes 712a, 712b. The differential signal creates an electric field between the droplet operations electrodes 712a, 712b that changes and remains localized to a region proximate to the droplet operations electrodes 712a, 712b. The localized electric field allows localized detection of a droplet in the region immediately proximate to the droplet operations electrodes 712a, 712b independent of the reference plane electrode.

FIG. 8 illustrates a functional block diagram of an example of a microfluidics system 800 that includes a droplet actuator 805, which is one example of a fluidics cartridge. Further, microfluidics system 800 includes capacitance measurement capability for the purpose of sensing droplets at electrodes. Digital microfluidic technology conducts droplet operations on discrete droplets in a droplet actuator, such as droplet actuator 805, by electrical control of their surface tension (electrowetting). The droplets may be sandwiched between two substrates of droplet actuator 805, a bottom substrate and a top substrate separated by a droplet operations gap. The bottom substrate may include an arrangement of electrically addressable electrodes. The top substrate may include a reference electrode plane made, for example, from conductive ink or indium tin oxide (ITO). Optionally, the reference electrode may be provided along a first substrate (e.g. the top or bottom substrate), while droplet operations electrodes are provided along the second substrate (e.g. the opposite of the top and bottom substrate). The sensing signal is representative of a plate capacitance exhibited between the reference electrode and the droplet operations electrode. The plate capacitance varies based on the presence or absence of a droplet at the droplet operation gap in the region between a corresponding droplet operations electrode and the reference electrode. The bottom substrate and the top substrate may be coated with a hydrophobic material. Droplet operations are conducted in the droplet operations gap. The space around the droplets (i.e., the gap between bottom and top substrates) may be filled with an immiscible inert fluid, such as silicone oil, to prevent evaporation of the droplets and to facilitate their transport within the device. Other droplet operations may be effected by varying the patterns of voltage activation; examples include merging, splitting, mixing, and dispensing of droplets.

Droplet actuator 805 may be designed to fit onto an instrument deck (not shown) of microfluidics system 800. The instrument deck may hold droplet actuator 805 and house other droplet actuator features, such as, but not limited to, one or more magnets and one or more heating devices. For example, the instrument deck may house one or more magnets 810, which may be permanent magnets. Optionally, the instrument deck may house one or more electromagnets 815. Magnets 810 and/or electromagnets 815 are positioned in relation to droplet actuator 805 for immobilization of magnetically responsive beads. Optionally, the positions of magnets 810 and/or electromagnets 815 may be controlled by a motor 820. Additionally, the instrument deck may house one or more heating devices 825 for controlling the temperature within, for example, certain reaction and/or washing zones of droplet actuator 805. In one example, heating devices 825 may be heater bars that are positioned in relation to droplet actuator 805 for providing thermal control thereof.

A controller 830 of microfluidics system 800 is electrically coupled to various hardware components of the apparatus set forth herein, such as droplet actuator 805, electromagnets 815, motor 820, and heating devices 825, as well as to a detector 835, a capacitance sensing system 840, and any other input and/or output devices (not shown). Controller 830 controls the overall operation of microfluidics system 800. Controller 830 may, for example, be a general purpose computer, special purpose computer, personal computer, or other programmable data processing apparatus. Controller 830 serves to provide processing capabilities, such as storing, interpreting, and/or executing software instructions, as well as controlling the overall operation of the system. Controller 830 may be configured and programmed to control data and/or power aspects of these devices. For example, in one aspect, with respect to droplet actuator 805, controller 830 controls droplet manipulation by activating/deactivating electrodes. In accordance with some embodiments, the controller 830 includes a processor that directs operation of the EW driver and CM device. The processor within the controller 830 directs the EW driver 310 to perform droplet operations in connection with the droplet operations electrodes of interest to move, split or otherwise manage droplet activity. The processor of the controller 830 also directs the CM device 320 perform droplet sensing operations, simultaneously with or intermittently between the droplet movement operations.

In one example, detector 835 may be an imaging system that is positioned in relation to droplet actuator 805. In one example, the imaging system may include one or more light-emitting diodes (LEDs) (i.e., an illumination source) and a digital image capture device, such as a charge-coupled device (CCD) camera. Detection can be carried out using an apparatus suited to a particular reagent or label in use. For example, an optical detector such as a fluorescence detector, absorbance detector, luminescence detector or the like can be used to detect appropriate optical labels. Systems designed for array-based detection are particularly useful. For example, optical systems for use with the methods set forth herein may be constructed to include various components and assemblies as described in Banerjee et al., U.S. Pat. No. 8,241,573, entitled “Systems and Devices for Sequence by Synthesis Analysis,” issued on Aug. 14, 2012; Feng et al., U.S. Pat. No. 7,329,860, entitled “Confocal Imaging Methods and Apparatus,” issued on Feb. 12, 2008; Feng et al., U.S. Pat. No. 8,039,817, entitled “Compensator for Multiple Surface Imaging,” issued on Oct. 18, 2011; Feng et al., U.S. Patent Pub. No. 20090272914, entitled “Compensator for Multiple Surface Imaging,” published on Nov. 5, 2009; and Reed et al., U.S. Patent Pub. No. 20120270305, entitled “Systems, Methods, and Apparatuses to Image a Sample for Biological or Chemical Analysis,” published on Oct. 25, 2012, the entire disclosures of which are incorporated herein by reference. Such detection systems are particularly useful for nucleic acid sequencing embodiments.

Capacitance sensing system 840 may be any circuitry for detecting capacitance at a specific electrode of droplet actuator 805. Capacitance sensing system 840 may be used to monitor the presence and/or absence of a droplet on the droplet operations electrodes. Capacitance sensing system 840 can be, for example, electrode drive circuit 300 of FIG. 3 that includes capacitance measurement device 320, wherein electrode drive circuit 300 has capability of multiplexing capacitance sensing signals with drive voltages. Namely, electrode drive circuit 300 can be used to both drive droplet operations electrodes and to sense the presence and/or absence of droplets at the droplet operations electrodes. In another example, capacitance sensing system 840 can be electrode drive circuit 700 of FIG. 7.

Droplet actuator 805 may include disruption device 845. Disruption device 845 may include any device that promotes disruption (lysis) of materials, such as tissues, cells and spores in a droplet actuator. Disruption device 845 may, for example, be a sonication mechanism, a heating mechanism, a mechanical shearing mechanism, a bead beating mechanism, physical features incorporated into the droplet actuator 805, an electric field generating mechanism, armal cycling mechanism, and any combinations thereof. Disruption device 845 may be controlled by controller 830.

In the foregoing embodiments, capacitors and resistors are illustrates as the coupling circuits. Although it is recognized that additional and/or alternative components may be used to provide the described features and functions.

It will be appreciated that various aspects of the present disclosure may be embodied as a method, system, computer readable medium, and/or computer program product. Aspects of the present disclosure may take the form of hardware embodiments, software embodiments (including firmware, resident software, micro-code, etc.), or embodiments combining software and hardware aspects that may all generally be referred to herein as a “circuit,” “module,” or “system.” Furthermore, the methods of the present disclosure may take the form of a computer program product on a computer-usable storage medium having computer-usable program code embodied in the medium.

Any suitable computer useable medium may be utilized for software aspects of the present disclosure. The computer-usable or computer-readable medium may be, for example but not limited to, an electronic, magnetic, optical, electromagnetic, infrared, or semiconductor system, apparatus, device, or propagation medium. The computer readable medium may include transitory embodiments. More specific examples (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the methods and apparatus set forth herein may be written in an object oriented programming language such as Java, Smalltalk, C++ or the like. However, the program code for carrying out operations of the methods and apparatus set forth herein may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user's computer, for example, may entirely execute the program code or only partly execute the program code. The program code may be a stand-alone software package that is at least partly on the user's computer and/or partly executed on a remote computer or entirely on a remote computer or server. In the latter scenario, the remote computer may be connected to the user's computer through a communications network.

The methods and apparatus set forth herein may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network may even include wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The methods and apparatus set forth herein may be applied to any wireless/wireline communications network, regardless of physical componentry, physical configuration, or communications standard(s).

Certain aspects of present disclosure are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the present disclosure.

The foregoing detailed description of embodiments refers to the accompanying drawings, which illustrate specific embodiments of the present disclosure. Other embodiments having different structures and operations do not depart from the scope of the present disclosure. Furthermore, the foregoing description is for the purpose of illustration only, and not for the purpose of limitation.

1. An electrode drive circuit, the circuit comprising:
a droplet operations electrode;
an electrowetting (EW) driver connected to the droplet operations electrode by a signal path, the EW driver to supply an electrowetting drive signal component to the droplet operations electrode;
a capacitance measurement (CM) device connected to the droplet operations electrode by the signal path, the CM device to sense a sensing signal component indicative of at least one of a presence or absence of a droplet at the droplet operations electrode; and
a first coupling circuit positioned between the EW driver and the droplet operations electrode along the signal path; and
a second coupling circuit positioned between the CM device and the same droplet operations electrode along the signal path.

2. The circuit of claim 1, wherein the first coupling circuit represents a DC coupling circuit to allow both DC and AC signals to pass there through, while attenuating the sensing signal component from the droplet operations electrode.

3. The circuit of claim 1, wherein the second coupling circuit represents an AC coupling circuit to block at least a portion of the drive signal component from reaching the CM device.

4. The circuit of claim 1, wherein the signal path is to carry the drive signal component and sensing signal component simultaneously and superimposed upon one another.

5. The circuit of claim 1, wherein the EW driver and CM device alternately utilize the signal path in a time interleaved manner.

6. The circuit of claim 1, wherein the second coupling circuit is to block at least a portion of the drive signal component having a frequency at or below a drive signal cut off frequency.

7. The circuit of claim 6, wherein the drive signal cut off frequency is 500 Hz.

8. The circuit of claim 1, wherein the first coupling circuit is to block at least a portion of the sensing signal component having a frequency at or above a sensing signal cut off frequency.

9. The circuit of claim 8, wherein the sensing signal cutoff frequency is 5000 Hz.

10. An apparatus, comprising:
a droplet actuator comprising first and second substrates that are separated by a droplet operations gap;
a droplet operations electrode provided on at least one of the first and second substrates and located proximate to the droplet operations gap;
an electrowetting (EW) driver connected to the droplet operations electrode by a signal path, the EW driver to supply an electrowetting drive signal component to the droplet operations electrode;
a capacitance measurement (CM) device connected to the droplet operations electrode by a signal path, the CM device to sense a sensing signal component indicative of at least one of a presence or absence of a droplet at the droplet operations electrode; and
a first coupling circuit positioned between the EW driver and the droplet operations electrode along the signal path; and
a second coupling circuit positioned between the CM device and the same droplet operations electrode along the signal path.

11. The apparatus of claim 10, further comprising a plurality of the droplet operations electrodes having corresponding signal paths, wherein the EW driver and CM device are connected to the droplet operations electrodes over the corresponding signal paths, and where the EW driver and CM device are connected over a common one of the signal paths with a corresponding one of the droplet operations electrodes.

12. The apparatus of claim 10, further comprising first and second droplet operations electrodes having an interleaved pattern and arranged in a coplanar configuration, the EW driver to drive the first and second droplet operations electrodes in a common mode in connection with moving droplets, the CM device to operate the first and second droplet operations electrodes in a differential mode to generate an electric field within the droplet in connection with a sensing operation.

13. The apparatus of claim 10, further comprising a printed circuit board including a trace that is at least partially surrounded by AC shielding traces, the trace defining the signal path to carry the drive signal component and the sensing signal component.

14. The apparatus of claim 10, further comprising a reference electrode provided along the first substrate, the droplet operations electrode provided along the second substrate, wherein the sensing signal is representative of a plate capacitance exhibited between the reference electrode and droplet operations electrode, the plate capacitance varying based on the presence or absence of a droplet at the droplet operation gap.

15. A method, comprising:
supplying an electrowetting (EW) drive signal component from an EW driver to the droplet operations electrode along an signal path;
receiving a sensing signal component from the droplet operations electrode at a capacitance measurement (CM) device along the signal path;
determining a presence or absence of a droplet at the droplet operations electrode based on the sensing signal component; and
blocking the drive signal component from reaching the CM device along the signal path.

16. The method of claim 15, further comprising performing a droplet operation, utilizing the drive signal component, while determining the presence or absence of the droplet at the droplet operations electrode based on the sensing signal component.

17. The method of claim 15, further comprising at least partially attenuating the sensing signal component along an EW branch of the signal path to the EW driver.

18. The method of claim 15, wherein the blocking operation is performed along a CM branch of the signal path.

19. The method of claim 15, wherein the determining operation includes determining when a capacitance measured at the droplet operations electrode is above or below a capacitance threshold.

20. The method of claim 19, wherein the determining operation includes identifying the absence of the droplet when an amount of the capacitance is below the capacitance threshold, and identifying the presence of the droplet when the amount of the capacitance is at or above the capacitance threshold.
